(19) United States
(12) Patent Application Publication
(10) Pub. No.: US 2004/0159388 A1
(43) Pub. Date: Aug. 19, 2004

(54) Method and apparatus for defining the position of the edge surface of piled, e.g. board-like objects

(76) Inventor: Kari Perala, Uusikyla (FI)

Correspondence Address: BIRCH STEWART KOLASCH & BIRCH, PO BOX 747, FALLS CHURCH, VA, 22040-0747, US

(21) Appl. No.: 10/478,131

(22) PCT Filed: May 21, 2002
(86) PCT No.: PCT/FI02/00431

(30) Foreign Application Priority Data
May 21, 2001 (FI) 20011063

(51) Int. Cl. B05C 11/00

(52) U.S. Cl. 156/64; 118/663

(57) ABSTRACT

Method for determining the position of an edge surface of e.g., boardlike objects (11) arranged in a pile (12) and for marking the objects by means of a print head, in which method the height of the edge surface and/or its position in space is measured by means of a measuring element, in which the actual deviation of the edge surface (13) from a theoretical basic plane is determined by measuring the spatial coordinates of the edge surface and the movements of the print head are controlled using the information thus determined so that its distance from the marking point remains at a desired or a substantially constant value.

The present invention relates to a method as defined in the preamble of claim 1 and to an apparatus for determining the position of the edge surface of a pile consisting of boardlike objects to allow further actions, e.g. marking of the boards.

In the manufacture of various board products, such as e.g. chipboards, the boards may be provided with markings giving information such as manufacturer, type, date of manufacture of the board or the like. There are systems in which such a marking is made in individual boards, e.g. on an edge of the board. Systems are also known in which the marking is made on the edge of the boards while the boards are in a pile. The marking is produced using e.g. an ink jet print head or equivalent.

A drawback regarding the marking of boards is that the pile may be inaccurately positioned or it may be in an oblique position on a conveyor, in which case the distance of the edge surfaces of the boards in the pile as well as the distance of individual boards from the print head may vary. The print quality is therefore bad and the print is mostly misplaced.

The object of the present invention is to achieve a new type of method for determining the position of the edge surface of a pile consisting of e.g. boardlike objects. Such information can be used e.g. to improve the quality of a marking as the print head can be guided accurately relative to the position of the edge surface of the board.

The invention is mainly characterized in that, according to the invention, the height of the pile and the position of the edge plane are determined by the aid of the corner points. On the basis of the data obtained, it is possible e.g. to adjust the distance of a print head according to the plane of the print area so that the distance of the print head from the board edge remains at a desired value, generally constant. In addition, the marking can be applied accurately in the middle portion of each board because, based on the measured pile height data and the number of boards piled on top of each other, the average board thickness and exact print head scanning lines can be calculated.

In more precise terms, the invention is characterized by what is presented in the claims.

In the following, the invention will be described in detail by the aid of an example with reference to the attached drawings, wherein

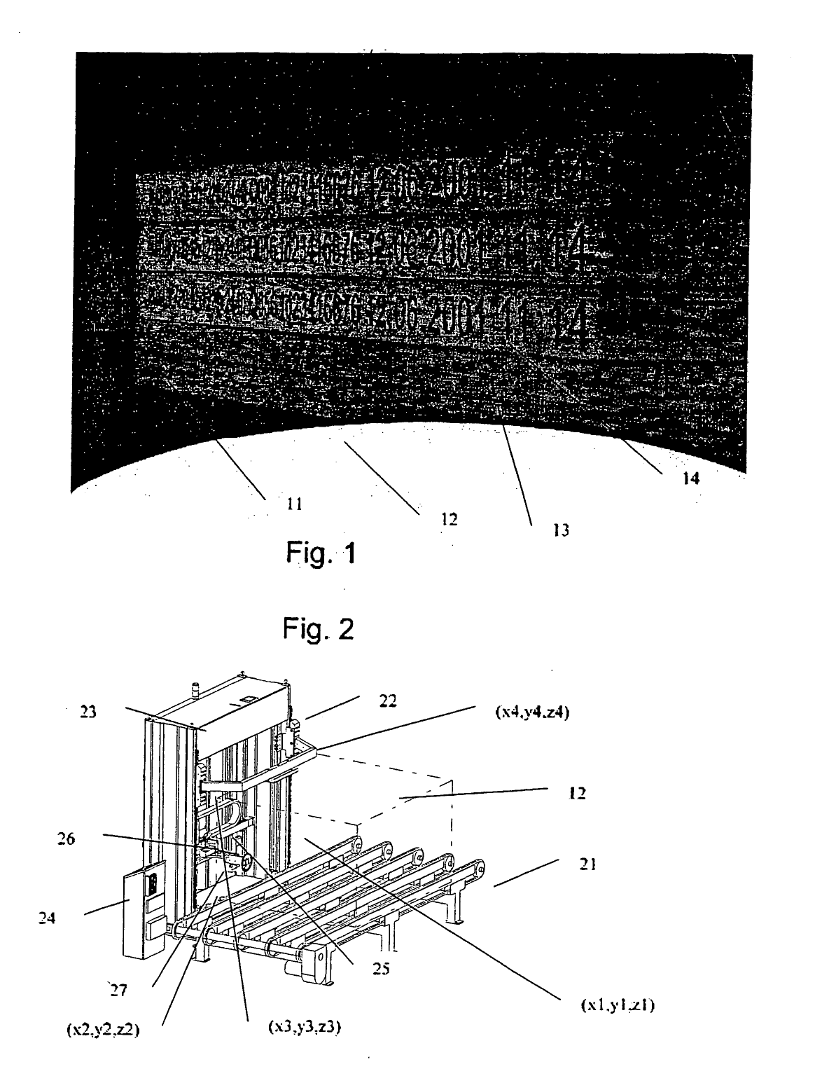

FIG. 1 presents a pile of boards provided with a marking on one edge,

FIG. 2 presents a marking station provided with a measuring apparatus according to the invention.

FIG. 1 shows chipboards 11 arranged one over the other as a pile 12. Printed on an edge 13 of each board 11 is a marking 14 consisting of information such as type, size, manufacturer, date of manufacture of the board and similar data. The pile 12 of boards may consist of a plurality of boards placed on top of each other, and its height may typically be e.g. about 1 m. In addition, the pile may comprise e.g. protective boards placed under and over it.

The pile of boards 12 is brought e.g. on a chain conveyor 21 (FIG. 2) to a measuring and marking station 22, where a marking as shown in FIG. 1 is made on the edge of each board. The station consists of a frame part 23, a printer unit 24 controlling the printing, and a system, e.g. a PLC system (not shown in the figure) for controlling the movable parts of the measuring and marking station. Fitted in the frame part 23 are guide bars 25 permitting motion in the directions of the three principal axes x, y, z, with a measuring head and a print head 26 (e.g. a photocell measuring distance and an ink jet print head) fitted on the guide bars, and actuators 27 for moving and guiding the measuring/print head in directions x, y, z.

The system works as follows:

The pile of boards 12 is brought by the conveyor 21 to the measuring and marking station. Specifications of the boards in the pile (number of boards, whether a protective board is used over and/or under the pile, thickness of protective boards, etc.) are fed into the control unit.

After this, the measurement and marking are performed as follows (using a x-z-y coordinate system where x is the longitudinal direction of the boards, y is the height direction and z is the depth direction in the transverse direction of the boards):

When the pile arrives at the marking position, e.g. the following programmed chain of actions takes place:

1. The measuring/print head, provided with a photocell for measuring distance, rises to the measuring position for the measurement of e.g. the lower left-hand corner of the printing area and is adjusted to a position closer to the pile.

2. The distance (z1) of the lower left-hand corner is stored in memory.

3. The measuring/print head moves to the measuring position for the measurement of the lower right-hand corner and the distance (z2) is stored in memory.

4. The measuring/print head rises upwards at a high speed and the distance-metering photocell senses the height of the upper edge of the pile.

5. The measuring/print head changes direction and descends slowly trying to find the pile height, and when it is found, it is stored in memory (y1).

6. The measuring/print head descends further for about 1 second and stops to measure the distance of the upper right-hand corner of the printing area.

7. The distance of (z3) of the upper right-hand corner is stored in memory.

8. The measuring/print head moves to the measuring position for the measurement of the upper left-hand corner of the printing area and the distance (z4) is stored in memory.

The spatial coordinates (x1,y1,z1), (x2,y2,z2), (x3,y3,z3) and (x4,y4,z4) of the corner points of the printing area have now been determined.

Between these points, two line segments are formed; (x1,y1,z1), (x4,y4,z4) on the left-hand side of the printing area and (x2,y2,z2), (x3,y3,z3) on the right-hand side of the printing area.

9. The measuring/print head is adjusted to the height at which the printing is to be started and the printing distance is adjusted on the basis of the measurement result for the upper right-hand corner (z4) so that the print head comes to a distance of about 10 mm from the pile.

10. The measuring/print head is moved from left to right at a printing speed and simultaneously the print head distance control system (Z motion) adjusts the distance so that, when the printing on the line is completed, the distance of the head is at the position determined by the measurement result (z3) for the upper right-hand corner. The speed of the Z motion is proportionated to the printing motion (X motion) so that the distance of the print head remains constant during the X motion.

11. The measuring/print head performs a line change movement in the y direction and at the same time the z-motion is adjusted to point (x3,y3,z3) point of line segment (x2,y2,z2).

12. The measuring/print head is moved from right to left at the printing speed and simultaneously the print head distance control system (Z motion) adjusts the distance so that, when the printing on the line is completed, the print head is at point (x4,y4,z4) of line segment (x1,y1,z1).

13. The measuring/print head performs a line change movement in the y-direction and at the same time the z-motion is adjusted to point (x4,y4,z4) of line segment (x1,y1,z1).

This action is continued until all the boards in the pile have been marked. If there are separate packaging boards on top and under the pile, these can be marked with a separate marking. It is also possible provide each board with an individual marking.

The printing is started from the top of the pile, and a marking can be made on several boards simultaneously. If the boards are thin, typically under 6 mm, it is possible to print a common text on two boards.

The essential point is that the distance of the print head from the material to be marked remains fairly accurately the same even though the pile may be in a slanting position, successive piles may be at different distances from the printer or the piles may be skewed.

It is obvious to the person skilled in the art that the invention is not limited to the embodiment described above, but that it may be varied within the scope of the following claims. The measuring station is not necessarily combined with the printing station, but it may be a separate unit. The range of application of the invention is not limited to boardlike objects; instead, the invention can also be applied in the case of other objects of suitable form.

1. Method for determining the position of an edge surface of e.g. boardlike objects (11) arranged in a pile (12) and for marking the objects by means of a print head, in which method the height of the edge surface and/or its position in space is measured by means of a measuring element,
characterized in that
in the method, the actual deviation of the edge surface (13) from a theoretical basic plane is determined by measuring the spatial coordinates of the edge surface, and
the movements of the print head are controlled using the information thus determined so that
its distance from the marking point remains at a desired or a substantially constant value.

2. Method according to claim 1, characterized in that the measurement is performed out in a controlled manner by means of a measuring head (26) moving in XYZ directions and provided with a distance measuring element.

3. Method according to claim 1 or 3, characterized in that, in the method:
the measuring head moves to the measuring position for the measurement of one corner of the edge surface to be measured and is adjusted to a position closer to the pile,
the distance (z1) of the corner is stored in memory,
the measuring head moves to the measuring position for the measurement of a second corner of the edge surface and this second distance (z2) is stored in memory,
the measuring head is moved vertically and the distance measuring element senses the height at which the pile comes to an end,
the measuring head is caused to change direction and determine the height of the pile and store it in memory (y1),
the measuring head is caused to stop at a third corner of the marking area in order to measure the distance,
the distance (z3) of the third corner is stored in memory,
the measuring head is caused to move to the measuring position for the measurement of the fourth corner of the marking area and the fourth distance (z4) is stored in memory.

4. Apparatus for determining the position of an edge surface of e.g. boardlike objects (11) arranged in a pile (12) to allow a marking to be made, said apparatus comprising a control unit, a measuring head (26) moved by a motion work and measuring the height and/or position of the edge surface, and a print head for marking the objects,
characterized in that
the measuring head (26) measures the spatial coordinates of the edge surface, and
the control unit controls the movements of the print head by using the data thus determined so that its distance from the marking point remains at a desired or a substantially constant value.

5. Apparatus according to claim 4, characterized in that the control unit causes the print head to move along scanning tracks calculated using the edge surface position data so that the distance of the print head during the printing of the lines of markings remains at a desired or a substantially constant value.

6. Apparatus according to claim 4, characterized in that the control unit corrects the distance of the print head from the marking point by means of the measuring head during the printing so that the distance of the print head from the marking point remains at a desired or a substantially constant value.

7. Apparatus according to claim 6, characterized in that the distance measuring element is placed in the same measuring/print head moving in a controlled manner in the XYZ direction.

8. Apparatus according to any one of claims 4-7, characterized in that the height position of the print head for the printing of a marking line is determined from the measured height data and from the number of piled objects that has been given to the control unit and on the basis of data concerning the thicknesses of possible protective boards.
